(19) United States
(12) Patent Application Publication
(10) Pub. No.: US 2007/0297926 A1
(43) Pub. Date: Dec. 27, 2007

(54) MULTISTEP DIAPHRAGM PUMP

(76) Inventors: Mingxian Wang, Shenyang (CN); Sheng Liu, Panjin (CN)

Correspondence Address: GREENBERG TRAURIG, LLP, MET LIFE BUILDING, 200 PARK AVENUE, NEW YORK, NY, 10166, US

(21) Appl. No.: 11/459,715

(22) Filed: Jul. 25, 2006

(30) Foreign Application Priority Data
Jun. 21, 2006 (CN) 200610046990.8

(51) Int. Cl. F04B 17/00; F16J 3/00

(52) U.S. Cl. 417/413.1; 92/97

(57) ABSTRACT

A multistep diaphragm pump comprising: a pump body; a main shaft; a reciprocated driving mechanism driven by the main shaft; a driving shaft connected with the reciprocated driving mechanism and extended into the working chamber of the pump body; on the relevant driving shaft there is provide a plurality of dish type diaphragms which are connected in series; in front of each dish type diaphragm there is fixed a piston having a sealing ring; between the adjacent two dish type diaphragms is filled with hydraulic medium, wherein the piston situated in the front of the most front dish type diaphragm directly contacts with the liquid material in the working chamber, a suction check valve and a discharge check valve are provided in the working chamber; the driving mechanism is constituted by the main shaft, the eccentric shaft, the driving plate, the articulated bearings and the bridge board, therefore the driving shaft can be moved reciprocally. The advantages of the pump is that the pump has small volume and compact structure; reasonable transmission, automatic clearance adjustment, noiseless property; high load pressure of the multistep diaphragm, high safe coefficient; the diaphragm and the piston protect each other in the sealing chamber, and there is no sealing, no leakage, and such pump has a long service life.

### TECHNICAL FIELD

The present invention relates to a pump and in particular to a multistep diaphragm pump for transporting liquid material.

### BACKGROUND ART

The existing diaphragm pump usually adopts a pneumatically driven diaphragm or a hydraulically driven diaphragm, and the diaphragm is usually a single-step diaphragm, such single-step diaphragm can not bear high pressure satisfactorily. Once the diaphragm is damaged, the diaphragm can not function in a normal manner. U.S. Pat. No. 3,809,506 disclosed such a single-step diaphragm pump. In addition, U.S. Pat. No. 4,049,366 disclosed a double-diaphragm pump; the disadvantage of the double-diaphragm is that it is not suitable for bearing a larger load. Furthermore, the driving mechanism for reciprocating the diaphragm usually adopts a crank lever mechanism or a cam-reset spring mechanism. In the situation where the crank lever mechanism is used, it results in a large volume, therefore, the space occupied by the equipment and the costs incurred are increased. In Chinese patent CN 1,587,697A filed on 24, Sep. 2004, there is disclosed a single-step diaphragm pump with a reset spring. In the situation where a reset spring is used, the space occupied by the spring is small, however, the spring is prone to damage, therefore it need to be replaced quite often. Such frequent replacement of the spring will influence the normal operation of the pump.

### SUMMARY OF INVENTION

Considering the drawback of the pump in the prior art, it is an object of the present invention to provide a multistep diaphragm pump which has a small volume, high transport efficiency, low noise, long service life, and is easy to maintain.

According to the present invention, there is provided a multistep diaphragm pump which includes: a pump body; a main shaft; a reciprocated driving mechanism driven by the main shaft; a driving shaft connected with the reciprocated driving mechanism and extended into the working chamber of the pump body; a suction check valve and a discharge check valve provided at the front end of the working chamber, wherein: on the relevant driving shaft there is provide a plurality of dish type diaphragms which are connected in series; in front of the each dish type diaphragm there is fixed a piston; between the adjacent dish type diaphragms there is filled with a hydraulic medium; the piston situated in the front of the most front dish type diaphragm directly contacts with the liquid material in the working chamber; between the each piston and the wall of the working chamber there is provided a sealing ring.

Wherein the driving mechanism includes: an eccentric shaft mounted on the main shaft; a driving plate mounted on the eccentric shaft by means of a bearing; several (the quantity can be determined depending on the practical need) articulated bearings and a bridge board. Said articulated bearings are arranged between the driving plate and the bridge board, the other end of the bridge board is arranged on a central articulated bearing which is fixed on the main shaft. The relevant driving shaft is connected with one of the articulated bearings, and extends through the hole formed on the driving plate; therefore, the driving shaft can drive the dish type diaphragm and the piston.

In order to damp the impingement between the driving plate and the bridge board and decrease the noise, an elastic body is provided in the said articulated bearing.

In order to protect the dish type diaphragm through automatically recovering the liquid loss caused by the pressure difference on the two sides of the piston, on each piston there is provided a check valve.

In order to maintain a good clearance fit of the transmission system and make the multistep diaphragm pump realize automatic adjustment during long time operation, between the front end of the main shaft and pressing cover of the main shaft, there is provided an elastic body for adjusting the bearing clearance of the main shaft.

The eccentric shaft mounted on the main shaft swings by means of the rotation of the main shaft, and transfers the rotation of the main shaft into a reciprocating linear movement of the driving shaft through the driving plate and the articulated bearings, therefore, the plurality of pistons on the driving shaft and the dish type diaphragms reciprocate together, and finally make the suction check valve and the discharge check valve in the working chamber realize the transport of the liquid material.

### BRIEF DESCRIPTION OF DRAWINGS

FIG. 1 is a sectional view of the multistep diaphragm pump according to the present invention;

FIG. 2 is a left end view of the FIG. 1;

FIG. 3 and FIG. 4 are the enlarged views showing the state of check valve when the check valve is closed and opened respectively;

FIG. 5 is a multistep diaphragm combining system having piston protection function;

FIG. 6 is a multistep diaphragm combining system without piston protection function.

Throughout these drawings, the same reference number denotes the same component.

### EMBODIMENT OF INVENTION

In the following description, the terms “front”, “rear” respectively refer to the “right side”, “left side” of the paper.

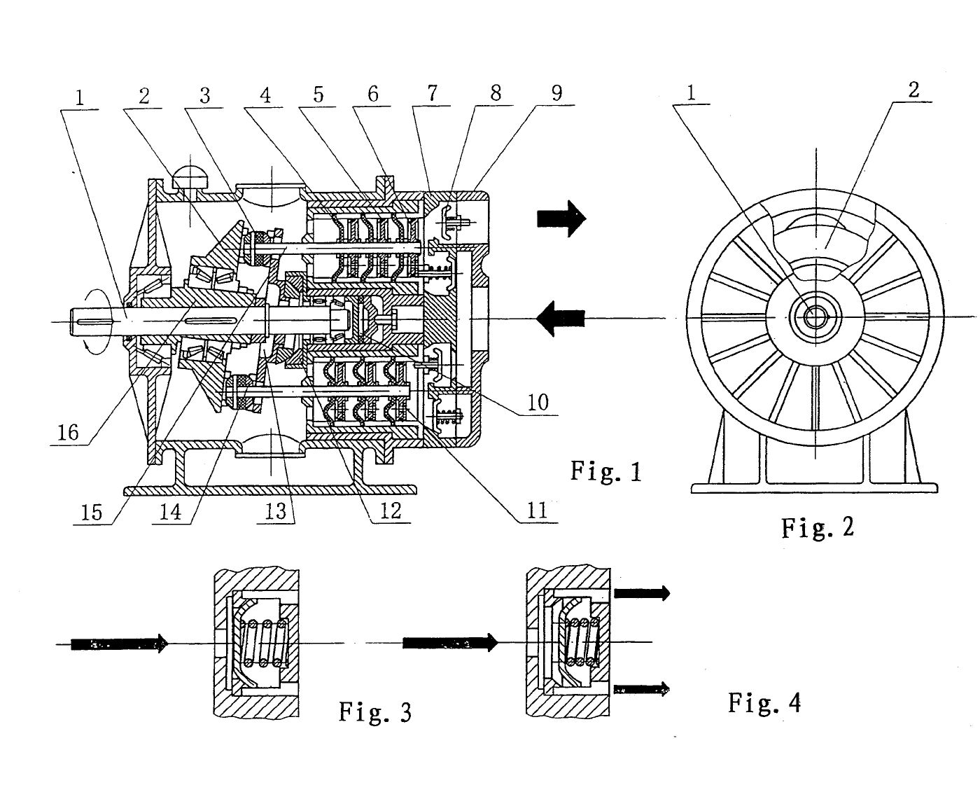

As shown in FIG. 1, the multistep diaphragm pump includes: a pump body; a main shaft 1; an eccentric shaft 16; a driving plate 2; several articulated bearings 14; a bridge board 13; a driving shaft 15, dish type diaphragms 4 and pistons 6 arranged in a working chamber; a valve plate 7; a pump cover 9. The eccentric shaft 16 is mounted on the main shaft 1, the driving plate 2 is mounted on the eccentric shaft 16 by means of a bearing; The main shaft 1, the eccentric shaft 16 and the driving plate 2 constitute a swing mechanism which is situated in the working chamber filled with lubricating oil. The articulated bearing 14 is arranged between the driving plate 2 and the bridge board 13. The bridge board 13 is mounted on the main shaft 1 by means of the central articulated bearing 12. The bridge board 13 is provided with a through hole at the central part. The main shaft 1 extends through the hole. On the two sides of the bridge board 13, there are also provided through holes through which the driving shafts 15 extend. One end of the driving shaft 15 is connected with the articulated bearing 14, the other end of the driving shaft 15 is engaged with the dish type diaphragms 4 and the piston 6, therefore, the rotation of the main shaft 1 is transferred into a linear movement of the driving shaft 15 by means of the swing mechanism.

The valve plate 7 and the pump cover 9 are arranged at the front end of the pump body, the suction and discharge check valves 8 are arranged in the valve plate 7.

On the driving shafts 15, there are provided plurality of dish type diaphragms 4 connected in series. In front of the each dish type diaphragm 4, there is fixed a piston 6. The adjacent diaphragms and the wall of the working chamber constitute a chamber which is filled with a hydraulic medium. The piston 6 situated in the front of the most front dish type diaphragm 4 directly contacts with the liquid material in the working chamber. Between the piston 6 and the wall of the working chamber there is provided a sealing ring 5. There is provided a check valve 11 on the piston 6.

In order to damp the impingement between the driving plate 2 and the bridge board 3 and decrease the noise, an elastic body 3 is provided in the said articulated bearing 14. The said elastic body 3 is made of anti-friction and anti-erosion material. During the suction of the pump, the driving plate 2 presses one side of the articulated bearing 14 which has an elastic body sandwiched in the central part, the other side of the articulated bearing 14 presses the bridge board 13. The bridge board 13 reversely presses the lower articulated bearing 14 by means of the central articulated bearing 12, therefore make the system integral. The driving shaft 15 is moved synchronously with the driving plate 2 by means of said articulated bearing, therefore, the driving shaft 15 can reciprocate without noise.

In order to maintain a good clearance fit of the transmission system and make the multistep diaphragm pump realize automatic adjustment during long time operation, between the front end of the main shaft 1 and pressing cover of the main shaft, there is provided an elastic body 10 for adjusting the bearing clearance of the main shaft. In the preliminary assembly state, a preload is applied on the elastic body 10 by means of a bolt or the like in a well known manner; therefore, the elastic body 10 has a preliminary deformation. During operation, the elastic body 10 automatically adjusts the bearing clearance of the main shaft within a certain range, therefore the cost of maintenance can be decreased and the service life of the equipment can be lengthened. Preferably, the elastic body 10 is made of the same material as that of the elastic body 3.

In order to protect the dish type diaphragm through automatically recovering the liquid loss caused by the pressure difference on the two sides of the piston, on each piston 6 there is provided a check valve 11. The operation of the apparatus and particularly the operation of the check valve 11 of the present invention will be explained with reference to the FIGS. 1, 3 and 4. Firstly, the liquid material to be transported first is suctioned into the working chamber. During the suction, the check valve 11 on the piston 6 can not be opened, because the suction pressure is not larger than 1 standard atmospheric pressure, the check valve 11 can not be opened at such a suction pressure. Therefore, during the suction, the existence of the check valve will not influence the suction procedure. The discharge procedure follows the suction procedure, during discharging the liquid material, the driving plate 2 presses the articulated bearing 14 on the left of the elastic body 3, the articulated bearing 14 directly transmits the power to the driving shaft 15. The pressure applied on the diaphragms and the pistons during discharging the liquid material is far greater than the pressure during the suction procedure, and is in the opposite direction to that of the pressure during suction procedure, therefore, the check valve 11 closes. As a result, the existence of the check valve 11 will not influence the discharging procedure. The function of the check valve is as follows: when suffering an impact due to an abnormal pressure or a cavitation, the hydraulic medium leaking through the sealing ring on the piston will accumulate in the left chamber of the piston, therefore, the pressure in the left chamber is increased. When the pressure in the left chamber is increased to a pressure which is larger than 1 standard atmospheric pressure, the check valve 11 is opened, and the liquid medium flows back to the right chamber, after the pressure relieves, the check valve 11 closes, therefore, the diaphragm can be protected.

Technical Effects

1. The operation time without malfunction is very long, and there is a unique function with respect to the special fluid such as destructive dense oil which contains some fine sands or the like. The diaphragms in the working chamber do not contact the liquid material; the shield type piston is used to prevent the diaphragms from damage caused by the liquid. The diaphragms and the space between them are driven by the liquid; the liquid loss caused by the pressure difference on the two sides of the piston can be automatically recovered. Because multistep diaphragm is used, the pump has higher safe coefficient, long time of anti-fatigue, and can bear high pressure, and even the individual diaphragm is damaged, the normal operation can not be affected.

2. The structure is advanced. In this structure, there is particularly provided elastic bodies at two positions, the elastic bodies 3 in the articulated bearing are clipped by the driving plate and the bridge board, the elastic body 10 is arranged between the end of the main shaft and the press covers of the main shaft and is used to adjust the bearing clearance of the main shaft. The existence of the elastic bodies at these two positions assure that the clearance is always relatively small during the long period of operation of the transmission system, especially, the operation within a working chamber filled with lubricating oil results in lower noise, leakproof property and long service life.

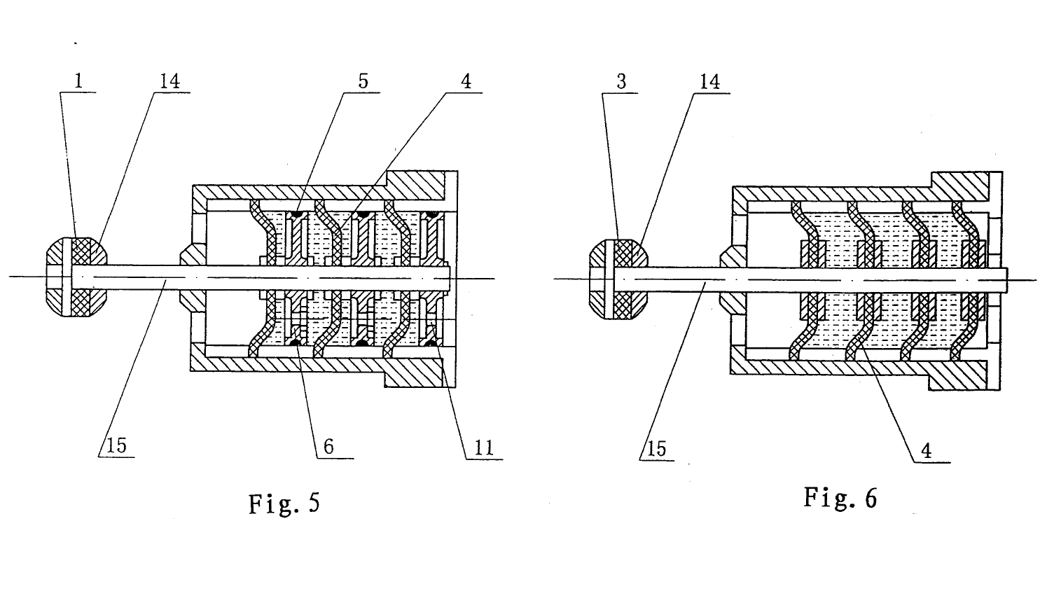

3. In the present invention, there are provided two kinds of multistep diaphragm combining system which has a good interchangeability, one is a multistep diaphragm combining system having the piston protection as shown in FIG. 5, the other is a multistep diaphragm combining system without the piston protection as shown in FIG. 6.

The list of the components is as follows:
1: main shaft
2: driving plate
3: elastic body
4: diaphragm
5: sealing ring
6: piston
7: valve plate
8: suction, discharge check valve
9: pump cover
10: elastic body
11: check valve
12: central articulated bearing
13: bridge board
14: articulated bearing
15: driving shaft
16: eccentric shaft

1. A multistep diaphragm pump comprising: a pump body; a main shaft (1); a reciprocated driving mechanism driven by the main shaft (1); a driving shaft (15) connected with the reciprocated driving mechanism and extended into a working chamber of the pump body; a suction check valve and a discharge check valve provided at the front end of the working chamber, wherein: on the relevant driving shaft (15) there is provide a plurality of dish type diaphragms (4) which are connected in series; in front of the each dish type diaphragm (4) there is fixed a piston (6); between the adjacent dish type diaphragm there is filled with a hydraulic medium; the piston situated in the front of the most front dish type diaphragm directly contacts with the liquid material in the working chamber; between the each piston (6) and the wall of the working chamber there is provided a sealing ring (5).

2. A multistep diaphragm pump according to claim 1 wherein: the said reciprocated driving mechanism includes: an eccentric shaft (16) mounted on the main shaft (1); a driving plate (2) mounted on the eccentric shaft by means of a bearing; a bridge board (13) mounted on the main shaft (1) by means of a central articulated bearing (12); several articulated bearings (14) between the driving plate (2) and the bridge board (13).

3. A multistep diaphragm pump according to claim 2 wherein: in each said articulated bearing (14) there is provided an elastic body (3).

4. A multistep diaphragm pump according to claim 3 wherein: the said elastic body (3) is made of anti-friction and anti-erosion material.

5. A multistep diaphragm pump according to claim 1 wherein: on one side of each piston there is provided a check valve (11).

6. A multistep diaphragm pump according to claim 1 wherein: between the front end of the main shaft (1) and pressing cover of the main shaft (1), there is provided an elastic body (10) for adjusting the bearing clearance of the main shaft (1).
